(19) United States
(12) Patent Application Publication
(10) Pub. No.: US 2017/0058603 A1
(43) Pub. Date: Mar. 2, 2017

(54) LADDER STABILIZATION DEVICE AND SYSTEM

(71) Applicant: Troy Bullington, St. Cloud, FL (US)

(72) Inventor: Troy Bullington, St. Cloud, FL (US)

(21) Appl. No.: 14/837,490

(22) Filed: Aug. 27, 2015

(51) Int. Cl. E06C 7/42; E06C 7/00

(52) U.S. Cl. CPC E06C 7/42; E06C 7/006

(57) ABSTRACT

A ladder stabilization device includes a generally L-shaped frame member having a horizontal section and a vertical section. A ladder connection hinge is disposed along one end of the frame, a foot is disposed along another end of the frame, and a panel member is connected therebetween. A ladder stabilization system includes two stabilization devices. The system transitions between an open configuration where each foot is engaged with the ground, and a closed configuration where each panel blocks the ladder steps.

### TECHNICAL FIELD

The present invention relates generally to safety devices, and more particularly to a stabilization device for ladders of all types.

### BACKGROUND

The statements in this section merely provide background information related to the present disclosure and may not constitute prior art.

Each year, thousands of people become injured or die after falling off of a ladder. Regardless of the type of ladder being used, one common problem involves the instability of the ladder, especially as a user nears the top end. This is particularly problematic with extension-type ladders wherein the top end is rested against a structure, and the bottom end rests on the ground. These ladders are most commonly utilized outdoors, where the ground can be soft or uneven. In many instances, the poor footing of the ladder can cause the weight of the ladder to shift and/or cause the upper portion of the ladder to slide laterally on the supporting structure, such as a roof, or tree branch, for example. When this occurs, the ladder and any occupant may fall resulting in property damage and/or injury. Of course, other ladders such as stepladders often suffer from the same problems when one or more of the ladder feet shift on or in the ground.

Although several forms of safety ladders are known in the art, each of these devices are typically formed as a permanent feature of the ladder which adds cost, bulk and weight to the same, thereby rendering the ladder commercially untenable.

Accordingly, it would be beneficial to provide a lightweight ladder stabilization device that can be connected to any type of ladder to solve the above noted problems, while not suffering from the drawbacks noted above.

### SUMMARY OF THE INVENTION

The present invention is directed to a ladder stabilization device and system. One embodiment of the present invention can include a ladder stabilization device having a sturdy frame and panel member. In one embodiment, the device can include a hinge along a horizontal member, and a foot along a vertical member.

Another embodiment of the present invention can include a ladder stabilization system that includes two ladder stabilization devices. Each of the devices can be pivotally secured onto a ladder, and can transition between an open configuration and a closed configuration. In the open configuration, the system functions to extend the footprint of the ladder, thereby providing additional lateral stabilization to prevent the ladder from moving during use.

When in the closed configuration, the stabilization devices are positioned along the front of the ladder, and the panel members prevent access to the ladder steps. Such a feature ensures that the ladder cannot be utilized without the stabilization devices in the extended position.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a frontal view of a ladder stabilization device that is useful for understanding the inventive concepts disclosed herein.

FIG. 2 is a perspective view of a ladder stabilization system in an open configuration, in accordance with one embodiment of the invention.

FIG. 3 is a perspective view of a ladder stabilization system in a closed configuration, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

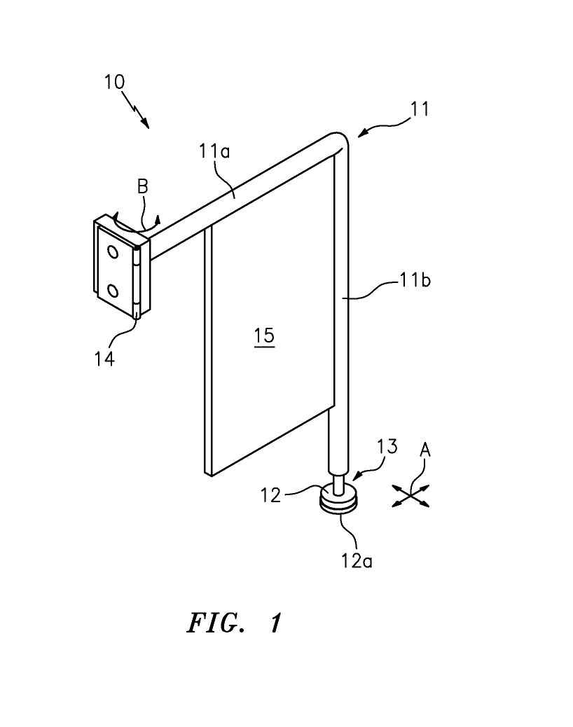

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As described herein, the terms “pivotally connected” and “pivotally secured” and all derivatives shall be used interchangeably to describe a situation wherein two objects are joined together in a manner that allows one or both of the objects to move, pivot and/or rotate about or in relation to the other object. Although described below predominantly as an attachment for existing ladders, other embodiments are also contemplated wherein the device can be incorporated into the new construction of a ladder as an integral component.

FIG. 1 illustrates one embodiment of a ladder stabilization device 10 that is useful for understanding the inventive concepts disclosed herein. As will be described throughout this document, a pair of stabilization devices can be pivotally attached to a ladder so as to stabilize the base of the ladder during use.

As shown, each stabilization device can include a generally L-shaped frame member 11 having a substantially horizontal frame section 11a and a substantially vertical frame section 11b. The frame is preferably constructed from a single piece of rigid material such as steel or aluminum, for example, however other materials such as plastic, PVC and various composites are also contemplated.

In one embodiment, the bottom end of the vertical frame section 11b can terminate into a frame foot 12. As the frame foot is designed to make contact with the ground, it is preferred that the foot include a generally circular shaped element having an outside diameter that is greater than the diameter of the frame section. Additionally, the bottom surface of the frame foot can be provided with a high friction material 12a such as rubber, for example, to prevent the foot from slipping during use. In various embodiments, the frame foot can be pivotally secured along the bottom of the frame member 11, so as to allow the bottom of the foot to rest evenly along the surface of the ground, even when the ground is not level (see arrow A). One suitable means for pivotally securing the frame and foot together include a ball and socket-type hinge 13, for example. Of course, any number of other known devices capable of securing the frame and foot together as described above are also contemplated.

A hinge 14 is provided along the horizontal frame section 11a, and functions to pivotally secure the stabilization device to a ladder. In one embodiment, the hinge can include a steel or metallic butt hinge that is capable of pivoting approximately 300 degrees or more across a plane, as shown by arrow B. Of course, any number of other types of hinges are also contemplated.

A barrier panel 15 can extend from the frame member 11 and can function to provide structural support to the same. Additionally, the barrier can function to display any type of markings such as a WARNING notice, or advertisement, for example. Moreover, as will be described below, the barrier can function to prevent a user from operating the ladder unless and until the stabilizers are in the extended position.

Although dimensions are not critical, in the preferred embodiment, the horizontal frame section 11a can preferably include a length of approximately 17 inches, and the vertical frame section 11b can preferably include a height of approximately 34 inches. Such dimensions being suitable for a 6 foot ladder. Of course, any number of other dimensions are also contemplated, as each device can be sized according to a type and height of ladder to which it is intended to be utilized with.

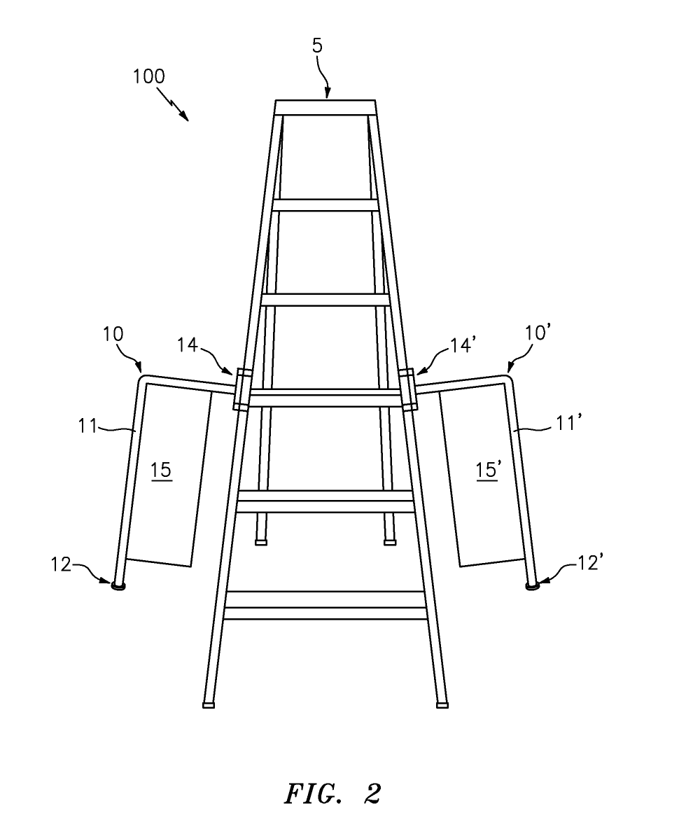

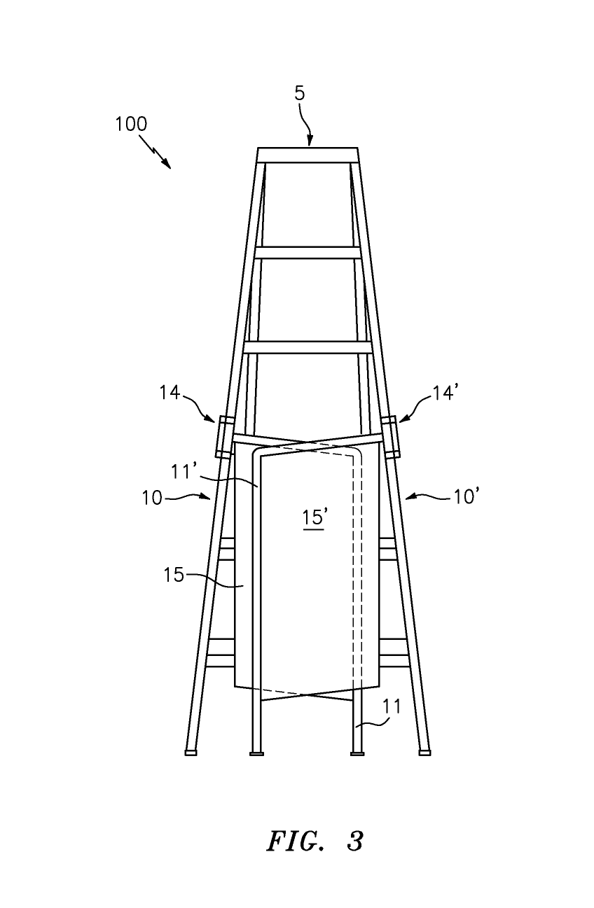

FIGS. 2 and 3 illustrate one embodiment of a ladder stabilization system 100, wherein a pair of the above described ladder stabilization devices 10 and 10′ are secured onto a ladder 5. Although illustrated with respect to a stepladder, this is for illustrative purposes only, as the inventive concepts disclosed herein are not limited to any particular shape or type of ladder.

As shown, each device 10 and 10′ can be affixed to sides of the ladder 5 via the hinges 14 and 14′, which can function to allow the stabilizers to transition between an open configuration and a closed/storage configuration. The hinges can be secured to the ladder utilizing connection hardware (not illustrated). The connection hardware can vary depending on the material of the ladder. For example, aluminum ladders can preferably utilize a combination of nuts and bolts, whereas a wood ladder can utilize screws. Of course, any means for securing the stabilizers onto the ladder so as to allow the device to be utilized as described herein are also contemplated.

FIG. 2 illustrates one embodiment of the ladder stabilization system 100 in the open configuration. As shown, when in the open configuration, each of the stabilizers can swing outward from the sides of the ladder 5 until the bottom surface of each foot 12 and 12′ makes contact with the ground. At this time, the footprint of the ladder is substantially extended, therefore providing much greater stabilization so as to prevent the ladder from falling during use.

FIG. 3 illustrates one embodiment of the ladder stabilization system 100 in the closed/storage configuration. As shown, when in the closed configuration, each of the stabilizers can swing inward from the sides of the ladder 5 until being positioned in front of the ladder steps. At this time, the barrier panels 15 and 15′ prevent access to the steps, thereby ensuring the ladder cannot be used unless and until the stabilizers are returned to the open position.

As described herein, one or more elements of the ladder stabilization device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individual elements such as the frame 11, foot 12 and panel 15, for example, may be formed together as one continuous element, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A ladder stabilization device, comprising:
an elongated, generally L-shaped frame member having a substantially horizontal section and a substantially vertical section;
a hinge that is disposed along one end of the substantially horizontal section, said hinge being configured to pivotally secure the device onto a ladder, and to position the device in each of an open configuration, and a closed configuration;
a frame foot that is disposed along a bottom end of the substantially vertical section, said frame foot being configured to engage a ground when the device is in the open configuration; and
a barrier panel that is in communication with each of the substantially horizontal section and the substantially vertical section, said barrier panel being configured to block access to a ladder step when the device is in the closed configuration.

2. The device of claim 1, wherein the frame foot includes a diameter that is greater than a diameter of the substantially vertical section.

3. The device of claim 1, wherein a bottom surface of the frame foot includes a high friction material.

4. The device of claim 1, wherein the frame foot is pivotally secured to the bottom end of the substantially vertical section.

5. The device of claim 4, further comprising:
a ball and socket hinge that is interposed between the frame foot and the substantially vertical section.

6. The device of claim 1, wherein the hinge includes a metallic butt hinge.

7. A ladder stabilization system, comprising:
a pair of ladder stabilization devices that are configured to be pivotally secured onto opposing sides of a ladder, each of said devices including
an elongated, generally L-shaped frame member having a substantially horizontal section and a substantially vertical section;
a hinge that is disposed along one end of the substantially horizontal section, said hinge being configured to secure the device onto the ladder, and to position the device in each of an open configuration, and a closed configuration;
a frame foot that is disposed along a bottom end of the substantially vertical section, said frame foot being configured to engage a ground when the device is in the open configuration; and
a barrier panel that is in communication with each of the substantially horizontal section and the substantially vertical section, said barrier panel being configured to block access to a ladder step when the device is in the closed configuration.

8. The device of claim 7, wherein the frame foot includes a diameter that is greater than a diameter of the substantially vertical section.

9. The device of claim 7, wherein a bottom surface of the frame foot includes a high friction material.

10. The device of claim 7, wherein the frame foot is pivotally secured to the bottom end of the substantially vertical section.

11. The device of claim 10, further comprising:
a ball and socket hinge that is interposed between the frame foot and the substantially vertical section.

12. The device of claim 7, wherein the hinge includes a metallic butt hinge.
